(19) United States
(12) Patent Application Publication
(10) Pub. No.: US 2026/0236002 A1
(43) Pub. Date: Aug. 13, 2026

(54) Control Apparatus and Control Method

(71) Applicant: Hitachi, Ltd., Chiyoda-ku, Tokyo (JP)

(72) Inventors: Yoshinari HORI, Tokyo (JP); Yoshiharu HAYASHI, Tokyo (JP); Yuya TOKUDA, Tokyo (JP)

(21) Appl. No.: 19/159,650

(22) PCT Filed: Nov. 20, 2023
(86) PCT No.: PCT/JP2023/041585

§ 371 Date: Aug. 26, 2025

(30) Foreign Application Priority Data
Mar. 30, 2023 (JP) 2023-056476

(51) Int. Cl. G05B 17/02

(52) U.S. Cl. CPC G05B 17/02

(57) ABSTRACT

State determination processing of determining a state of the control target from a measurement value of a control target, target state setting processing of using a control model including information on a second state to which a transition occurs in a case where first operation is performed on a control target in a first state to set a plurality of candidates for a target value for making the determined state of the control target closer to the second state that is a target state of the control target controlled by the target value that changes over time from the first state by performing the first operation, state transition estimation processing of estimating a state to which a transition occurs by the first operation for setting the control target to the target value for each of a plurality of the candidates based on the control model, and optimal operation determination processing of determining an operation amount of the first operation based on information regarding the estimated state to which a transition occurs by the first operation are performed.

### TECHNICAL FIELD

The present invention relates to a control apparatus and a control method for a plant.

### BACKGROUND ART

In recent years, the need for application of an AI technique to industrial fields has increased, and application cases of a control technique to which AI is applied have increased also in the field of process control.

For example, PTL 1 discloses an example in which “a future state estimation device including a model storage unit that stores a model for simulating a simulation target and a surrounding environment of the simulation target, a future state prediction result storage unit that stores information obtained by estimating a future state of the simulation target and a surrounding environment of the simulation target in infinite time or a time step ahead within a finite space in a form of probability density distribution, and a future state prediction arithmetic unit that performs calculation equivalent to a series using a model for simulating a future state of the simulation target and a surrounding environment of the simulation target in a form of probability density distribution.”

### CITATION LIST

### Patent Literature

PTL 1: JP 2019-159876 A

### SUMMARY OF INVENTION

### Technical Problem

According to PTL 1, it is possible to calculate a future state of a control target and a surrounding environment of the control target in infinite time ahead in a form of probability density distribution without depending on time to a future state desired to be predicted, and, by using a result of the calculation, it is possible to calculate an optimal control law in consideration of a future state in infinite time ahead. Therefore, for example, in a case where it is desired to switch from a certain state A (for example, temperature TA) to another state B (temperature TB) at an early stage in process control, it is possible to obtain an optimal operation condition for making a transition from the state A to the state B in a short time.

However, for example, in a temperature ramp-up process of a batch plant, it is necessary to operate so as to follow target temperature that changes over time as much as possible. In the AI control technique disclosed in PTL 1, it is possible to perform control to reach a target value such as certain target temperature at an early stage, but it is difficult to cope with a control target whose target value changes from moment to moment.

An object of the present invention is to provide a technique capable of determining an appropriate operation amount for a control target even in a case where a target value of the control target changes over time.

### Solution to Problem

A control apparatus according to the present invention is a control apparatus that controls a control target by a computer including a processor and a memory, in which the processor performs state determination processing of determining a state of the control target from a measurement value of the control target, target state setting processing of using a control model including information on a second state to which a transition occurs in a case where first operation is performed on a control target in a first state to set a plurality of candidates for a target value for making the determined state of the control target closer to the second state that is a target state of the control target controlled by the target value that changes over time from the first state by performing the first operation, state transition estimation processing of estimating a state to which a transition occurs by the first operation for setting the control target to the target value for each of a plurality of the candidates based on the control model, and optimal operation determination processing of determining an operation amount of the first operation based on information regarding the estimated state to which a transition occurs by the first operation.

### ADVANTAGEOUS EFFECTS OF INVENTION

According to the present invention, even in a case where a target value of a control target changes over time, an appropriate operation amount for the control target can be determined.

### BRIEF DESCRIPTION OF DRAWINGS

FIG. 1 is a diagram illustrating a functional configuration of a plant control system according to an embodiment of the present invention (first embodiment).

FIG. 2 is a diagram illustrating a schematic example of a computer.

FIG. 3 is a diagram illustrating an outline of a plant to be controlled in the present embodiment.

FIG. 4 is a diagram illustrating an example of target information illustrated in FIG. 1.

FIG. 5 is a diagram for explaining a state transition model.

FIG. 6 is a diagram illustrating a part of an example of data of a state transition matrix for creating a state transition model.

FIG. 7A FIG. ZA is a diagram for explaining a control model.

FIG. 7B is a diagram for explaining a control model.

FIG. 8 is a flowchart illustrating an example of a procedure of processing for determining an operation amount in an operation phase.

FIG. 9 is a diagram for explaining a method of selecting a target state.

FIG. 10 is a flowchart illustrating an example of a procedure of selection processing for selecting a plurality of target states in S82.

FIG. 11 is a diagram for explaining estimation of a state transition in a case where each target state is set for a selected candidate.

FIG. 12 is a diagram for explaining estimation of a state transition in a case where each target state is set for a selected candidate.

FIG. 13 is a diagram illustrating a functional configuration of the plant control system according to an embodiment of the present invention (second embodiment).

FIG. 14 is a diagram for explaining a method of state definition in a case of using adaptive resonance theory.

FIG. 15 is a flowchart illustrating an example of a procedure of evaluation processing for evaluating a state transition in consideration of a probabilistic state transition in estimating a state transition illustrated in S83.

FIG. 16 is an explanatory diagram for obtaining, together with a probability from a state transition model, a state transition destination when an optimal action is taken from a current state.

### DESCRIPTION OF EMBODIMENTS

Hereinafter, an embodiment of the present invention will be described with reference to the drawings. An embodiment is exemplification for explaining the present invention, and omission and simplification are made as appropriate for the sake of clarity of explanation. The present invention can be performed in other various forms. Unless otherwise specified, the number of each constituent element may be one or more than one. There is a case where a position, size, shape, range, and the like of each constituent element illustrated in the drawings do not represent an actual position, size, shape, range, and the like, in order to facilitate understanding of the invention. For this reason, the present invention is not necessarily limited to a position, size, shape, range, and the like disclosed in the drawings.

Examples of various types of information may be described in terms of expressions such as “table”, “list”, and “queue”. However, various types of information may be expressed in a data structure other than these. For example, various types of information such as “XX table”, “XX list”, and “XX queue” may be “XX information”. In describing identification information, expressions such as “identification information”, “identifier”, “name”, “ID”, and “number” are used. However, these can be replaced with each other.

In a case where there are a plurality of constituent elements having the same or similar functions, description may be made by attaching different subscripts to the same reference numerals. Further, in a case where a plurality of such constituent elements do not need to be distinguished from each other, the description may be made by omitting a subscript.

In an embodiment, there is a case where processing performed by executing a program is described. Here, a computer executes a program by a processor (for example, CPU and GPU), and performs processing defined by the program using a storage resource (for example, a memory), an interface device (for example, a communication port), and the like. For this reason, the subject of the processing performed by executing the program may be a processor. Similarly, the subject of the processing performed by executing the program may be a controller, a device, a system, a computer, or a node having a processor. The subject of the processing performed by executing the program only needs to be an arithmetic unit, and may include a dedicated circuit that performs specific processing. Here, the dedicated circuit is, for example, a field programmable gate array (FPGA), an application specific integrated circuit (ASIC), a complex programmable logic device (CPLD), or the like.

The program may be installed on the computer from a program source. The program source may be, for example, a program distribution server or a computer-readable storage medium. In a case where the program source is a program distribution server, the program distribution server may include a processor and a storage resource that stores a program to be distributed, and the processor of the program distribution server may distribute the program to be distributed to another computer. Further, in an embodiment, two or more programs may be realized as one program, or one program may be realized as two or more programs.

### First Embodiment

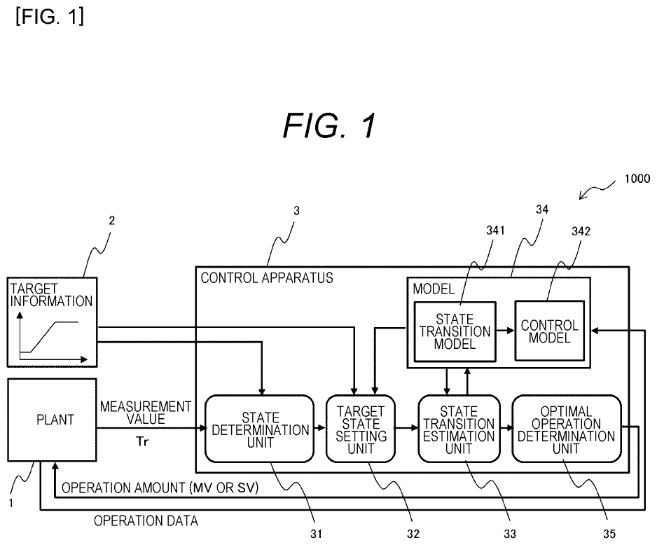

FIG. 1 is a diagram illustrating a functional configuration of a plant control system 1000 according to an embodiment of the present invention. The plant control system 1000 according to the present embodiment includes a plant 1, target information 2, and a control apparatus 3. The plant 1 is a control target, and is a batch plant in the present embodiment. The target information 2 is information indicating a target state of the plant 1 including a target value that changes over time, such as temperature of a reaction vessel of the plant 1. The control apparatus 3 is an apparatus that determines an optimal operation amount for the plant 1 from a measurement value measured in the plant 1 and the target information 2.

The control apparatus 3 includes a state determination unit 31, a target state setting unit 32, a state transition estimation unit 33, a model 34, and an optimal operation determination unit 35. The state determination unit 31 determines a current state of the plant from a measurement value of the plant 1. The state is separately defined by a value of a state amount such as temperature or pressure, for example. The target state setting unit 32 sets a target state that is a state as a target of control for the plant 1 from a state of the plant obtained by the state determination unit 31 and the target information 2, and a model 34 capable of simulating a characteristic of the plant 1.

The model 34 is a model created from operation data stored in the plant 1, and includes a state transition model 341 and a control model 342. The state transition model 341 is a model in which a state to which a transition occurs from a certain state when a certain action is taken is defined by a probability matrix. The control model 342 is a model that defines an optimal action for finally reaching a certain state B from a certain state A. The state transition estimation unit 33 uses the model 34 to estimate an optimal transition method from a current state to a target state set by the target state setting unit 32. The optimal operation determination unit 35 determines an operation amount to achieve an optimal transition from a result obtained by the state transition estimation unit 33. The operation amount is, for example, an MV value such as opening degree of a valve or an SV value (set value) of PID control. Further, the operation data is, for example, data including measurement values accumulated in time series obtained when a plant is operated, such as an operation amount with respect to the plant and temperature of the plant.

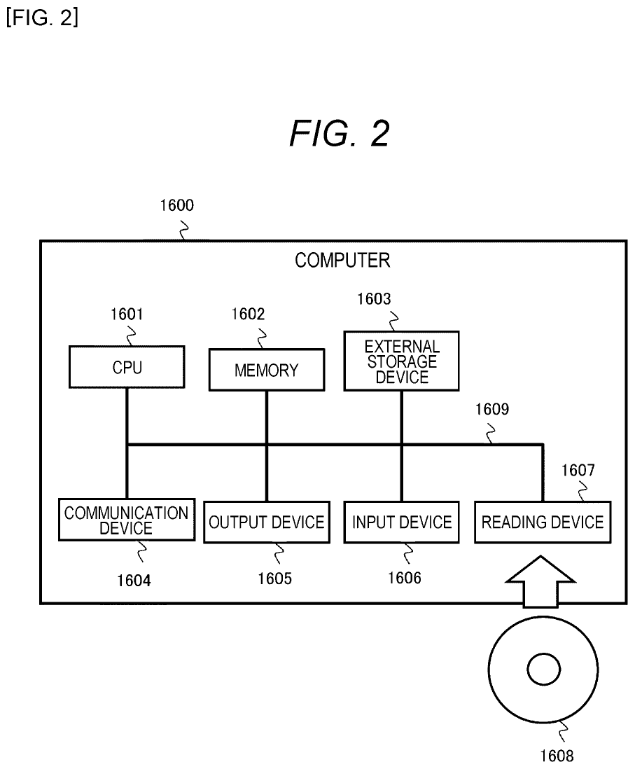

The control apparatus 3 illustrated in FIG. 1 can be realized by a general computer 1600 including, for example, as illustrated in FIG. 2 (computer schematic diagram), a CPU 1601, a memory 1602, an external storage device 1603 such as a hard disk drive (HDD), a reading device 1607 that reads and writes information from and to a portable storage medium 1608 such as a compact disk (CD) or a USB memory, an input device 1606 that receives input of various types of information such as a keyboard and a mouse, an output device 1605 such as a display that outputs various types of information that are input and used for processing, communication device 1604 such as a network interface card (NIC) for connecting to a communication network, and an internal communication line (referred to as a system bus) 1609 such as a system bus connecting these.

Further, various pieces of data (for example, the model 34) stored in the control apparatus 3 or used for processing can be realized by the CPU 1601 reading the data from the memory 1602 or the external storage device 1603 and using the data. Further, each unit (for example, the state identification unit 31, the target state setting unit 32, the state transition estimation unit 33, and the optimal operation determination unit 35) included in the control apparatus 3 can be realized by the CPU 1601 loading a predetermined program stored in the external storage device 1603 into the memory 1602 and executing the program.

The predetermined program and data described above may be stored (downloaded) in the external storage device 1603 from the storage medium 1608 via the reading device 1607 or from a network via the communication device 1604, and then may be loaded on the memory 1602 to be executed by the CPU 1601. Further, the predetermined program or data may be directly loaded onto the memory 1602 from the storage medium 1608 via the reading device 1607 or from a network via the communication device 1604 and executed by the CPU 1601.

Hereinafter, a case where the control apparatus 3 includes a certain computer will be exemplified, but all or a part of these functions may be distributed to one or a plurality of computers such as a cloud, and similar functions may be realized by communication with each other via a network.

Hereinafter, an embodiment of the present invention will be described in detail.

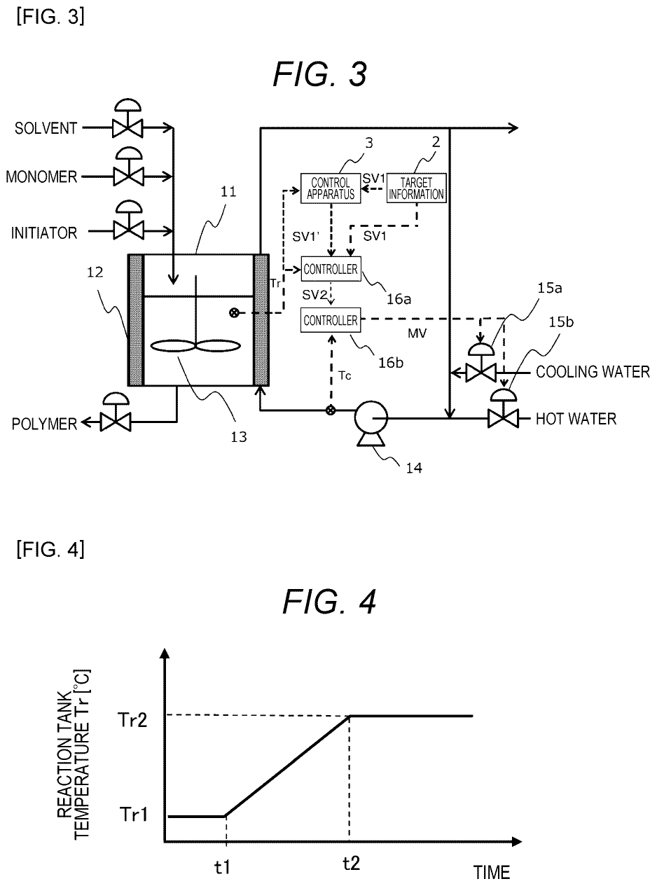

FIG. 3 is a diagram illustrating an outline of the plant 1 to be controlled in the present embodiment. The plant 1 is a batch plant for producing a polymer by a polymerization reaction. Main components are a reaction tank 11, a jacket 12, a stirring blade 13, a pump 14, a valve 15, and a controller 16. A monomer as a raw material is charged into the reaction tank 11 together with a solvent, and a polymerization reaction of the monomer is started by an initiator. During operation, charged monomers and the like are stirred by the stirring blade 13 so as to be as uniform as possible. Further, water whose temperature is adjusted is sent to the jacket 12 for temperature adjustment attached to the reaction tank 11 by the pump 14, and temperature Tr measured in the reaction tank is controlled to target temperature.

Next, a method of adjusting the temperature Tr of the reaction tank will be described in detail. In the present embodiment, in order to control the temperature Tr in the reaction tank, a system of changing inlet temperature Tc of the jacket 12 is employed. Specifically, the measured temperature Tr is input to a controller 16a, and the controller 16a compares the temperature Tr with a target value SV1 of the temperature Tr and gives a set value (SV2) of the jacket inlet temperature Tc to a controller 16b. For example, when the temperature Tr is higher than the target value SV1, the controller 16a adjusts the setting value SV2 of the jacket inlet temperature Tc in a downward direction, and when the temperature Tr is lower than the target value SV1, the controller 16a adjusts a setting value of the jacket inlet temperature To in an upward direction. The controller 16b compares the set value SV2 of the jacket inlet temperature Tc with an actual measurement value of the jacket inlet temperature Tc measured by a temperature sensor, and adjusts opening degree of valves 15a and 15b by an operation amount MV by which an actual measurement value of the jacket inlet temperature Tc approaches the set value SV2 of the jacket inlet temperature Tc.

FIG. 4 is a diagram illustrating an example of the target information illustrated in FIG. 1. In the present embodiment, a target is to increase temperature Tr1 of the reaction tank to temperature Tr2 between a time t1 and a time t2, and then to control the temperature Tr2 at a constant level. For this reason, temporal transition of a target value of the temperature Tr measured in the reaction tank is stored as the target information 2.

As described above, in the present plant, temperature control is performed by the controllers 16a and 16b even in a state where the control apparatus 3 is not provided, but temperature can be controlled more accurately by adding the control apparatus 3.

Next, the control apparatus 3 will be described. The control apparatus 3 inputs the temperature Tr of the reaction tank and the target value SV1 of the temperature Tr set as the target information, and gives a target value SV1′ to the controller 16a. In this case, the target value SV1 is not given to the controller 16a.

As described above, the model 34 is created from operation data of the plant 1. Therefore, the present control apparatus 3 has a learning phase of creating the model 34 from the operation data and an operation phase of controlling the plant 1 using the created model 34. First, a method in which the control apparatus 3 creates the model 34 in the learning phase will be described.

The model 34 includes the state transition model 341 and the control model 342. The state transition model is a model in which a state to which a transition occurs from a certain state when a certain action is taken is defined with probability. Therefore, in order to create the state transition model, it is necessary to first define three items: a state, an action, and transition time.

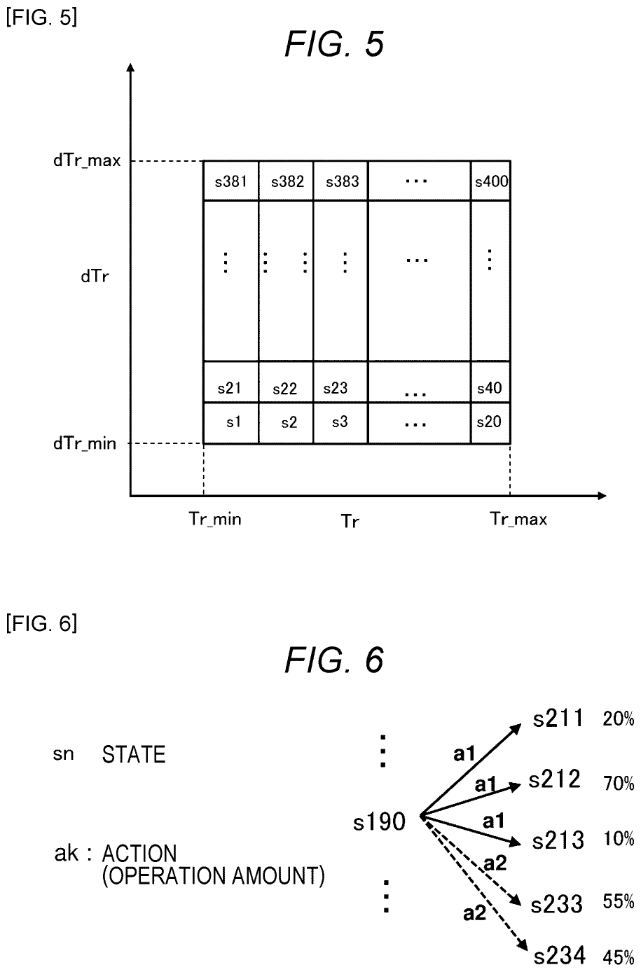

The state indicates, for example, a current state of a control target. That is, the state represents a state and behavior of a control target at the present time, and for example, the temperature Tr of the reaction tank at a certain time point is the above state. Further, the target state represents a state of a control target controlled by the target information, and examples of the target state include a state in which the temperature Tr of the reaction tank of the plant 1 becomes the target value SV1 or SV1′. In the present embodiment, as an example, the state is expressed by a combination of the temperature Tr of the reaction tank and a change amount dTr of the temperature Tr. Specifically, as illustrated in FIG. 5, with a minimum value Tr_min and a maximum value Tr_max of the temperature Tr of the reaction tank and a minimum value dTr_min and a maximum value dTr_max of the change amount dTr of the temperature Tr of the reaction tank as boundaries, 400 states divided into 20 in each direction were defined. Further, as an example, the action is a transition of the temperature Tr of the reaction tank to a set value discretized in 1° C. increments, and transition time is set to 10 seconds.

FIG. 6 illustrates a part of an example of data of a state transition matrix for creating a state transition model. The example of FIG. 6 shows that, in a case where an action al is taken from a state s190, the probability of transition to a state s211 after 10 seconds is 20%, the probability of transition to a state s212 is 70%, and the probability of transition to a state s213 is 10%. Further, the diagram shows that, even in the Same state s190, in a case where an action a2 is taken, the probability of transition to a state s233 is 55%, and the probability of transition to a state s234 is 45%. This state transition model can be obtained by discretizing past operation data into “states” and statistically processing a relationship between an action (set value of the temperature Tr of the reaction tank) and a state after 10 seconds, which is transition time.

Next, the control model will be described. The control model is a model expressing an optimal action for reaching a final target state (Sg) earliest in a certain state. The control model can be obtained from the state transition model. In the present embodiment, as an example, the control model is obtained by applying an algorithm for reinforcement learning. That is, by taking a certain action from a certain state, a large reward is given in a case where it is easier to approach a final target state. By determining an optimal action by such a method, the control model is determined. Note that a method of obtaining an optimal route for transition from a certain state to a final target state by a dynamic programming method may be employed.

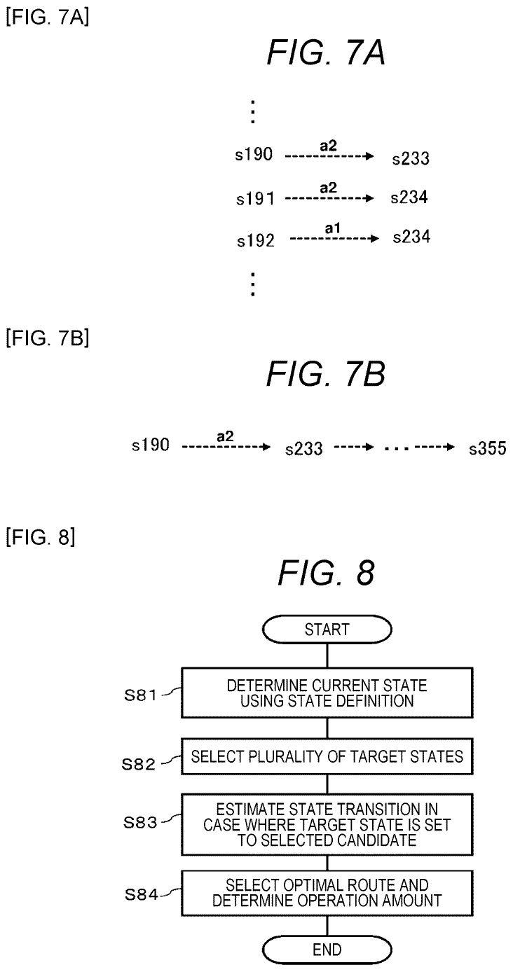

A part of an example of the control model is illustrated in FIGS. 7A and 7B. FIG. 7A illustrates an example of a database constituting the control model. In FIG. 7A, for a case where a certain target state is set, information of a second state to which a transition occurs when a first operation is performed on a control target in a certain first state is stored. For example, in the example illustrated in the first line of FIG. 7A, in a case of the state s190, taking the action a2 is an optimal action, and as a result, transition to the state s233 is indicated. In the state transition model of FIG. 6, a plurality of actions that are taken in the past and a transition probability at the time of taking the actions are expressed for a certain state, but in the control model, only an optimal action for final transition to a target state is expressed. As described above, in the learning phase, a state transition model is created from past operation data, and a control model is created from the state transition model. Note that the control model may store information necessary for transition from a certain initial state to a final target state for each combination of an initial state and a final state.

FIG. 7B illustrates an image of a control model in a case where transition occurs from the state s190 which is an initial state to a state s355 which is a final target state. Using information in the database constituting the control model illustrated in FIG. 7A, as illustrated in FIG. 7B, one or more actions, that is, operations necessary for transition from the state s190 that is an initial state to the state s355 that is a final target state are uniquely identified.

Next, the operation phase will be described. In the operation phase, an operation amount is determined in the processing flow illustrated in FIG. 8. FIG. 8 is a flowchart illustrating an example of a procedure of processing for determining an operation amount in the operation phase.

First, the state determination unit 31 of the control apparatus 3 identifies and determines a current state of the reaction tank by converting the temperature Tr of the reaction tank measured in the plant 1 into a state number according to the state definition illustrated in FIG. 5 (S81).

In the present embodiment, the control state determination unit 31 converts the temperature Tr of the reaction tank into a state number defined by the state definition. However, the control state determination unit 31 may perform processing as described below as a variation of such processing. That is, the control state determination unit 31 determines whether or not information regarding a state determined from a measurement value of the temperature Tr of the reaction tank measured in the plant 1 is in the state definition, and in a case where it is determined that the information regarding the state is not in the state definition, the temperature Tr of the reaction tank among the states included in the control model illustrated in FIGS. 7A and 7B may be converted into the state number in a state closest to the determined state. By this, even in a case where the state is not defined, the temperature Tr of the reaction tank can be converted into a state number.

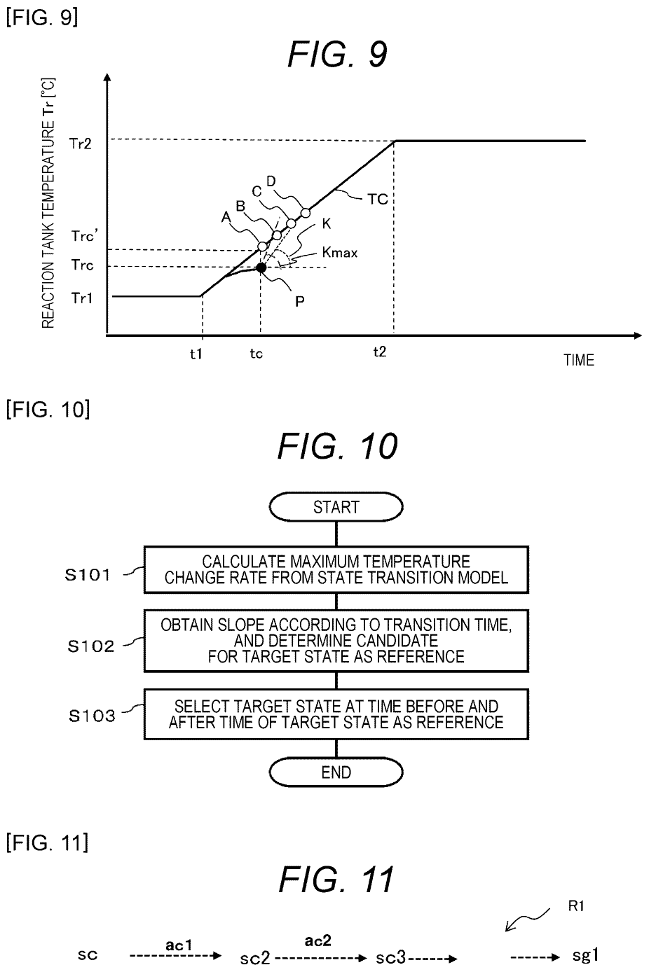

Next, the target state setting unit 32 selects a plurality of target states in a target curve TC representing a temporal transition of a target value defined as the target information (S82). A specific method will be described with reference to FIG. 9. FIG. 9 is a diagram for explaining a method of selecting a target state in a case where temperature of the reaction tank deviates from a target value Trc′ and reaches temperature Trc at a current time tc. In this case, a plurality of candidate points A, B, C, D, and the like indicating a time after the time tc are the target values. The number of these candidate points can be determined according to a characteristic, environment, and the like of a plant.

The target state setting unit 32 selects an appropriate candidate from these candidates. For example, in a case where a target state indicated by the point A with respect to a current time is set as the target value, the target state setting unit 32 takes an action to approach a target state of the point A by the control model. However, by the time of transition to the target state indicated by the point A, a target state at a time point of the transition also changes, and deviation from the target state is not eliminated. On the other hand, if the target state setting unit 32 selects a target value (for example, a target state at the point D) that is far from a current time by a certain amount or more, there is a possibility that the target state of the point D is reached earlier than a time when the target state of the point D should originally be reached. The reason for this is that, in the present control model, the target state setting unit 32 takes an action to reach the set target state earlier. Therefore, the target state setting unit 32 needs to appropriately select a target state itself.

In the present embodiment, the target state setting unit 32 obtains a slope K, which is a change ratio from temperature at a current time to temperature in a target state, and selects a candidate for the target state from the slope K and a maximum change rate of a state of a control target, so as to make it possible to select a candidate for the target state in consideration of a characteristic and environment of a plant. Specifically, a target state is obtained in a step below illustrated in FIG. 10.

FIG. 10 is a flowchart illustrating an example of a procedure of selection processing for selecting a plurality of target states in S82. As illustrated in FIG. 10, the target state setting unit 32 first obtains, from the state transition model, a maximum temperature change rate with a state at a current time as a base point (S101). As illustrated in FIG. 9, the maximum temperature change rate can be expressed by a slope Kmax at which a temperature change when a target state is reached after predetermined transition time elapses from a state at a current time. Here, the state transition model as described in FIG. 6 is used. However, instead of using such modeled data, data obtained by discretizing past operation data into states and statistically processing a relationship between an action and a state after transition time may be directly used.

Subsequently, the target state setting unit 32 obtains the slope K at a time according to transition time from the current time, and determines a candidate for a target value in the target state as a reference (S102). Specifically, the target state setting unit 32 obtains the slope K to a target value in each of target states in order from a target value in a target state at a time later in transition time from the current time (that is, a time that is temporally far from the current time) to a target value in a target state at a time earlier in transition time from the current time (that is, a time temporally close to the current time), and sets a target value in a state closest to the change rate obtained in S101 as a candidate for a target value in the target state as a reference. In FIG. 9, the target state setting unit 32 obtains slopes in order of the slope K (KD) between a point P at the current time and the point D farthest from the current time, the slope K(KC) between the point P at the current time and the point C second farthest from the current time, the slope K(KB) between the point P at the current time and the point B third farthest from the current time, and the slope K(KA) between the point P at the current time and the point A closest to the current time. Then, the target state setting unit 32 sets a point at which the slope is closest to the slope obtained in S101 among the obtained slopes as a candidate for the target value in the target state. In FIG. 9, for example, the target state setting unit 32 sets the point B as a candidate for the target value in the target state.

Further, the target state setting unit 32 uses a time of the candidate for the target value in the target state obtained in S102 as a reference, and selects n1 target values in the target state at a time before the reference time and n2 target values in the target state at a time after the reference time (S103). For example, the target state setting unit 32 selects the point A before the point B obtained in S102 and the points C and D after the point B. In this example, n1=1 and n2=2. The reason for selecting these points as points other than a reference point is that an error of a measurement value is considered. Further, the reason why the number of points at a time later than the reference time is larger than the number of points at a time earlier than the reference time is that there is a high possibility that reasonable operation is performed since there is a past operation record.

By performing the selection as described above, it is possible to set a case where a past change rate is fastest as a reference, set a first candidate (for example, the point B) for a target state closest to the reference, and select a target state (for example, the points A, C, and D) around the first candidate. Further, by selecting more candidates at a time later than the current time than at a time earlier than the current time, it is possible to select a candidate with high stability in consideration of a past operation record.

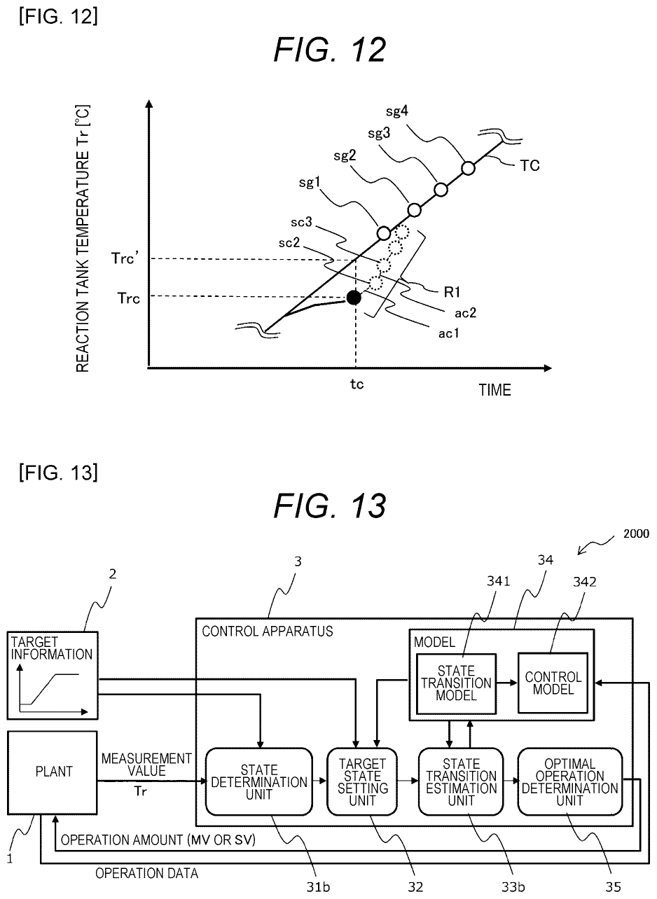

Returning to FIG. 8, next, the state transition estimation unit 33 estimates a state transition in a case where each target state is set for the selected candidate (S83). In the present embodiment, the state transition estimation unit 33 estimates a state transition by using a control model of a model 43. Specifically, as illustrated in FIGS. 11 and 12, the state transition estimation unit 33 obtains, from the control model, an optimal action ac1 in a case where the target state is sg1 and a state (sc2) to which transition occurs by the action ac1 with respect to a current state (sc). Next, the state transition estimation unit 33 sequentially obtains, for the state sc2, an optimal action ac2 toward the target state sg1 and a state sc3 to which a transition occurs by the action ac2, and determines a route R1 to the target state sg1. The state transition estimation unit 33 determines such a route also for candidates sg2, sg3, and sg4 for another target state, and obtains each route.

Next, the optimal operation determination unit 35 selects an optimal route from the routes obtained for the candidates of each target state by the state transition estimation unit 33, and determines an operation amount (S84). Specifically, the optimal operation determination unit 35 obtains, for each candidate, deviation between the route obtained for each candidate for the target state by the state transition estimation unit 33 and the target curve TC representing a temporal transition of a target value determined as the target information. The optimal operation determination unit 35 selects a candidate route of a target state with smallest deviation as an optimal route, and obtains the selected route as optimal operation for controlling the control target by an optimal operation amount to be performed in a current state. The optimal operation determination unit 35 performs processing of determining the optimal operation in each control cycle (for example, every 10 seconds) represented by transition time. By this, even in a case where actual data deviates from a target, an optimal operation amount can be determined for each control cycle.

Note that, in the present embodiment, output of the control apparatus 3 is SV1′ that is input of the controller 16a, but may be SV2′ that is input of the controller 16b or an opening degree command value for the valve 15.

### Second Embodiment

Next, a second embodiment of the present invention will be described. FIG. 13 illustrates a configuration of the second embodiment of the present invention. The second embodiment is different from the first embodiment in that, in a plant control system 2000 according to the present embodiment, the control apparatus 3 includes a state determination unit 31b different from that of the first embodiment and a state transition estimation unit 33b different from that of the first embodiment. Hereinafter, a difference from the first embodiment will be mainly described.

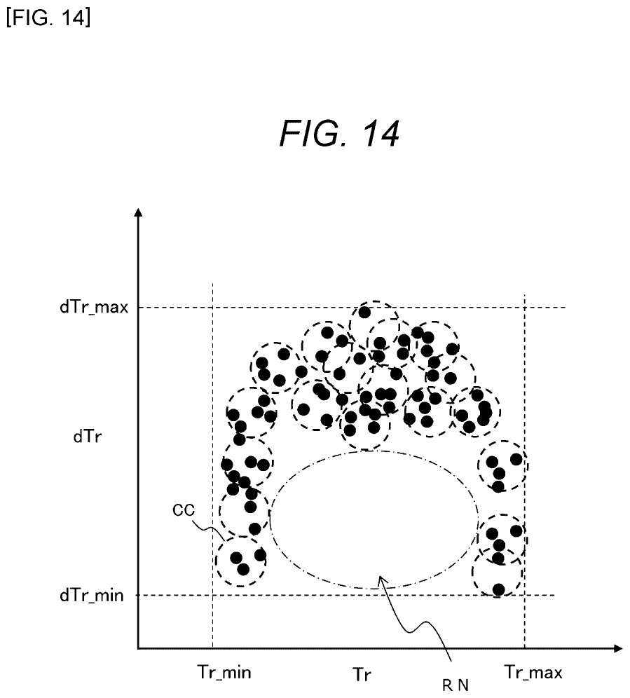

The state determination unit 31b performs state determination by using a data clustering technique. In the present embodiment, adaptive resonance theory is used as an embodiment of the data clustering technique. FIG. 14 illustrates a method of state definition in a case of using the adaptive resonance theory. In FIG. 14, as in FIG. 5, the horizontal axis represents the temperature Tr of the reaction tank, the vertical axis represents the change amount dTr of the temperature Tr of the reaction tank, and past operation data is plotted as a black circle. As illustrated in FIG. 14, in a process of raising the temperature from around the minimum value Tr_min of the temperature Tr of the reaction tank to around the maximum value Tr_max of the temperature Tr of the reaction tank, when the change amount dTr of the temperature Tr takes a small value, only operation data around the minimum value Tr_min of the temperature Tr or around the minimum value Tr_max of the temperature Tr exists. Therefore, in an area between them, the change amount dTr of the temperature Tr has a relatively large value, and thus there is an area RN where no operation data exists. Using the adaptive resonance theory, the state determination unit 31b generates a category by classifying operation data into fixed-data chunks as indicated by a dashed circle CC. For this reason, a category is not generated in an area where no operation data exists. Therefore, the state determination unit 31b can define as many states as necessary by defining the category as a state.

The state transition estimation unit 33b estimates a state transition by using a state transition model as described with reference to FIG. 6 in addition to a control model. In the control model, a transition occurs to one state by a certain action, but actually a transition occurs to another state probabilistically. Since information on this probabilistic state transition is included in the state transition model, in the second embodiment, the state transition is evaluated in consideration of the probabilistic state transition in estimation of the state transition illustrated in S83 of FIG. 8. In the present embodiment, evaluation is performed in a step below.

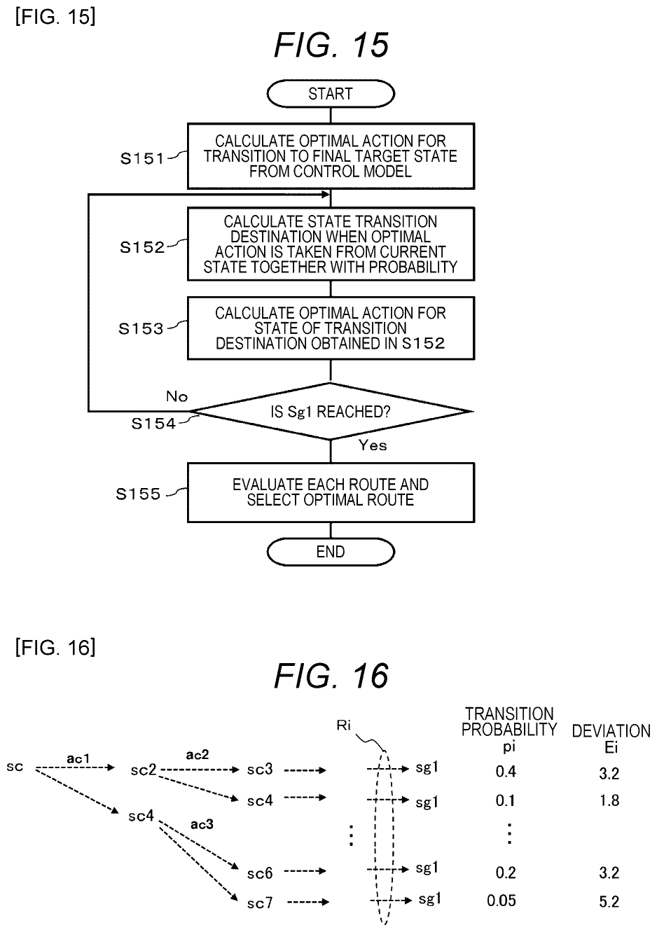

FIG. 15 is a flowchart illustrating an example of a procedure of evaluation processing for evaluating a state transition in consideration of a probabilistic state transition in estimation of the state transition illustrated in S83. As illustrated in FIG. 15, the state transition estimation unit 33b first obtains, from a control model, the optimal action ac1 for transition to the final target state sg1 from the current state sc (S151).

Subsequently, the state transition estimation unit 33b obtains a state transition destination when the optimal action ac1 is taken from the current state sc from the state transition model together with probability (S152). For example, the state transition estimation unit 33b obtains the states sc2 and sc4 to be state transition destinations when the action ac1 is taken in sc illustrated in FIG. 16 and probability at that time. By this, as illustrated in FIG. 6, the states s211, s212, and s213 to be state transition destinations when the action a1 is taken in a case where the current state is the state s190, and probabilities 20%, 70%, and 10% of these are calculated.

Subsequently, the state transition estimation unit 33b obtains an optimal action from a control model for the state obtained in S152 (S153). For example, the state transition estimation unit 33b obtains the action ac1 to be the action a1 at the time of transition to the state sc2 to be a state of a state transition destination (s212, 70%) having highest probability obtained in S152.

Furthermore, the state transition estimation unit 33b repeats processing similar to that in S153 for a state transition destination (for example, the states sc2, sc3, and the like) up to the target state sg1 (S154). That is, the state transition estimation unit 33b determines whether or not the target state sg1 is reached by an optimal action obtained from the control model in S153. In a case of determining that the target state sg1 is not reached by the optimal action (S154; No), the state transition estimation unit 33b returns to S152, and repeats the processing in and after S152. On the other hand, in a case of determining that the target state sg1 is reached by the optimal action (S154; Yes), the state transition estimation unit 33b proceeds to S155.

Finally, the state transition estimation unit 33b obtains deviation Ei between transition probability pi and a target curve for all i routes Ri reaching the target state sg1 obtained in the processing up to S154, obtains deviation when the target state sq1 is set as a target value by Σpi*Ei, and selects an optimal route from each route (S155).

In this way, by obtaining deviation for all possible transition routes, it is possible to more accurately evaluate a state transition, and it is possible to select an optimal route from among routes with high accuracy on average. Note that, in the above example, all the routes Ri are evaluated, but a route having a low probability to a certain extent may be excluded from the evaluation target. By this, the above-described effects can be obtained while a processing load is reduced.

As described above, by determining an operation amount for a control target as in the present control apparatus, an appropriate operation amount can be determined even in a process in which a target value changes over time.

Specifically, as described in the first embodiment, FIGS. 1 and 8, and the like, in the control apparatus 3 that controls a control target (for example, the plant 1) by the computer 1600 including a processor (the CPU 1602) and a memory (memory 1602), the processor performs the state determination processing (processing of the state determination unit 31) of determining a state of the control target from a measurement value of the control target, the target state setting processing (processing of the target state setting unit 32) of using the control model 342 including information on the second state (the temperature Tr after a current time, the state s233) to which a transition occurs in a case where the first operation (certain action a2) is performed on the control target in the first state (the temperature Tr at the current time, the state s190) to set a plurality of candidates for a target value (the target information 2) for making a state of the determined control target closer to the second state which is a target state of the control target controlled by the target value that changes over time from the first state by performing the first operation, the state transition estimation processing (processing of the state transition estimation unit 33) for estimating, for each of a plurality of the candidates, a state (for example, the route R1 to the target state sg1) to which a transition occurs by the first operation so that the control target becomes the target value based on the control model, and the optimal operation determination processing (processing of the optimal operation determination processing unit 35) for determining an operation amount of the first operation based on the estimated information regarding a state to which a transition occurs by the first operation. By this, even in a case where a target value of a control target changes over time, an appropriate operation amount for the control target can be determined. Then, a plant to be controlled can be appropriately controlled based on the determined operation amount.

Further, as the state transition model of the first embodiment and the second embodiment, as described with reference to FIGS. 5, 6, 14, and the like, the processor estimates, in the state transition estimation processing, based on the state transition model 341 including information on one or more states of a control target that can transition in a case where the first operation is performed on the control target in the first state and probability of transition to each of the one or more states of the control target, and the control model 342, information (for example, the state s211 after taking the action al in the state 190) on an operation amount of the first operation for setting the control target to the target value and a transition state at the time of performing an operation based on an operation amount of the first operation for each of a plurality of the candidates, and determines the first operation based on the estimated information in the optimal operation determination processing. By this, an operation amount for a control target can be determined in consideration of transition probability.

Further, as described as a variation in S81 of FIG. 8, in a case where there is no information regarding a state determined from a measurement value of the control target in the control state determination processing, the processor determines a state closest to the determined state among states included in the control model as a state of the control target. By this, even in a case where a state is not defined, it is possible to determine a state to which a transition occurs.

Further, as described with reference to FIG. 14 and the like of the second embodiment, the processor classifies states of the control target into a plurality of categories by predetermined data clustering (for example, clustering based on adaptive resonance theory) in the state determination processing, and estimates a state to which a transition occurs by the first operation by using the control model and the state transition model obtained by the classification in the state transition estimation processing. By this, since a state is defined excluding an area where operation data does not exist, it is possible to estimate a state to which a transition occurs while reducing a processing load.

Further, as described with reference to FIG. 9 and the like, in the target state setting processing, based on a maximum change rate (for example, the slope Kmax at which a change in temperature at the time of reaching a target state is maximized) at which a change in a state of the control target when a state of a current time point becomes the target state after predetermined transition time elapses is maximum and a change ratio (for example, the slope K at a time corresponding to transition time from a current time) between the state at the current time point and a candidate for the target value, the processor selects, as a candidate for the target value, the target value in which the maximum change rate and the change ratio satisfy a predetermined relationship (closest slope). By this, it is possible to select a candidate for a target state in consideration of a characteristic of a plant.

Further, as described with reference to FIG. 9 and the like, in the target state setting processing, the processor selects more candidates for the target value at a time point after the current time point than at a time point before the current time point. By this, it is possible to appropriately select a candidate for a target state having high stability in consideration of a past operation record.

Present invention is not limited to the above embodiment as such, and in an implementation stage, a constituent element can be modified and embodied without departing from the gist of the present invention, or a plurality of constituent elements disclosed in the above embodiment can be appropriately combined to implement the present invention. For example, in the above embodiment, a method of selecting a plurality of target values in a target state and selecting one of the selected target states is employed, but the configuration may be such that one target value in the selected target state is employed.

REFERENCE SIGNS LIST
1 plant
2 target information
3 control apparatus
31, 31b state determination unit
32 target state setting unit
33, 33b state transition estimation unit
34 model
341 state transition model
342 control model
35 optimal operation determination unit

1. A control apparatus that controls a control target by a computer including a processor and a memory, wherein
the processor performs:
state determination processing of determining a state of the control target from a measurement value of the control target;
target state setting processing of using a control model including information on a second state to which a transition occurs in a case where first operation is performed on a control target in a first state to set a plurality of candidates for a target value for making the determined state of the control target closer to the second state that is a target state of the control target controlled by the target value that changes over time from the first state by performing the first operation;
state transition estimation processing of estimating a state to which a transition occurs by the first operation for setting the control target to the target value for each of a plurality of the candidates based on the control model; and
optimal operation determination processing of determining an operation amount of the first operation based on information regarding the estimated state to which a transition occurs by the first operation.

2. The control apparatus according to claim 1, wherein
the processor:
estimates, in the state transition estimation processing, for each of a plurality of the candidates, information on an operation amount of the first operation for setting the control target to the target value and a transition state when an operation based on the operation amount of the first operation is performed based on a state transition model including information on one or more states of the control target to which a transition can occur in a case where the first operation is performed on the control target in the first state and probability of transition to each of the one or more states of the control target; and
determines the first operation based on the estimated information in the optimal operation determination processing.

3. The control apparatus according to claim 1, wherein
the processor determines, as a state of the control target, a state closest to the determined state among the states included in the control model in a case where there is no information regarding a state determined from a measurement value of the control target in the state determination processing.

4. The control apparatus according to claim 2, wherein
the processor:
classifies states of the control target into a plurality of categories by predetermined data clustering in the state determination processing; and
estimates a state to which a transition occurs by the first operation by using the control model and the state transition model obtained by the classification in the state transition estimation processing.

5. The control apparatus according to claim 2, wherein
in the target state setting processing, based on a maximum change rate at which a change in a state of the control target becomes the target state after predetermined transition time elapses from a state of a current time point and a change ratio between the state of the current time point and a candidate for the target value, the processor selects the target value by which the maximum change rate and the change ratio satisfy a predetermined relationship as a candidate for the target value.

6. The control apparatus according to claim 5, wherein
the processor selects, in the target state setting processing, more candidates for the target value at a time point after the current time point than at a time point before the current time point.

7. A control method of controlling a control target by a computer including a processor and a memory, the control method comprising:
determining a state of the control target from a measurement value of the control target;
using a control model including information on a second state to which a transition occurs in a case where first operation is performed on a control target in a first state to set a plurality of candidates for a target value for making the determined state of the control target closer to the second state that is a target state of the control target controlled by the target value that changes over time from the first state by performing the first operation;
estimating a state to which a transition occurs by the first operation for setting the control target to the target value for each of a plurality of the candidates based on the control model; and
determining an operation amount of the first operation based on information regarding the estimated state to which a transition occurs by the first operation.

8. The control method according to claim 7, further comprising:
estimating, in the estimating, for each of a plurality of the candidates, information on an operation amount of the first operation for setting the control target to the target value and a transition state when an operation based on the operation amount of the first operation is performed based on a state transition model including information on one or more states of the control target to which a transition can occur in a case where the first operation is performed on the control target in the first state and probability of transition to each of the one or more states of the control target; and
determining the first operation based on the estimated information in the determining.

9. The control method according to claim 7, further comprising:
determining, as a state of the control target, a state closest to the determined state among the states included in the control model in a case where there is no information regarding a state determined from a measurement value of the control target in the determining.

10. The control method according to claim 8, further comprising:
classifying states of the control target into a plurality of categories by predetermined data clustering in the determining; and
estimating a state to which a transition occurs by the first operation by using the control model and the state transition model obtained by the classification in the estimating.

11. The control method according to claim 8, further comprising, in the setting, based on a maximum change rate at which a change in a state of the control target becomes the target state after predetermined transition time elapses from a state of a current time point and a change ratio between the state of the current time point and a candidate for the target value, selecting the target value by which the maximum change rate and the change ratio satisfy a predetermined relationship as a candidate for the target value.

12. The control method according to claim 11, further comprising selecting, in the setting, more candidates for the target value at a time point after the current time point than at a time point before the current time point.
